(19) United States
(12) Patent Application Publication
(10) Pub. No.: US 2011/0283195 A1
(43) Pub. Date: Nov. 17, 2011

(54) DEVICE THEME MATCHING

(75) Inventor: Jared A. Brown, Kirkland, WA (US)

(73) Assignee: MICROSOFT CORPORATION, Redmond, WA (US)

(21) Appl. No.: 12/777,494

(22) Filed: May 11, 2010

(51) Int. Cl. G06F 3/048

(52) U.S. Cl. 715/738; 715/747; 715/744

(57) ABSTRACT

Various embodiments enable device theme matching. In at least some embodiments, a request for resources from a client device can be configured to include data to identify a theme that is active for the client device and/or selected programs or interfaces of the device. A web provider that receives the resource request can parse the request and make use of identifying data to ascertain a theme that is active for or associated with the client device. Based on the identifying data, the web provider can retrieve, generate, create, or otherwise obtain webpages that are configured to match or otherwise be consistent with the ascertained theme. The web provider can then communicate the configured webpages to the client device in response to the resource request.

### BACKGROUND

The popularity and variety of client devices is ever increasing. One way that various client devices can be employed by users is to execute a browser to obtain webpages and/or other resources available from web providers. Some client devices enable a user to set preferences and/or select a theme to customize the look and feel of interfaces and applications of the device. Traditionally, though, webpages available from web providers are developed independently of native interfaces and applications for the client devices. Accordingly, these webpages often can have an independent look and feel that is not configured to match a theme or other selected customizations for a device. This can result in a disconnected user experience that can appear unpolished and be distracting to the user.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Various embodiments enable device theme matching. In at least some embodiments, a request for resources from a client device can be configured to include data to identify a theme that is active for the client device and/or selected programs or interfaces of the device. A web provider that receives the resource request can parse the request and make use of identifying data to ascertain a theme that is active for or associated with the client device. Based on the identifying data, the web provider can retrieve, generate, create, or otherwise obtain webpages that are configured to match or otherwise be consistent with the ascertained theme. The web provider can then communicate the configured webpages to the client device in response to the resource request.

### BRIEF DESCRIPTION OF THE DRAWINGS

The same numbers are used throughout the drawings to reference like features.

FIG. 1 illustrates an operating environment in accordance with one or more embodiments.

FIG. 2 is a flow diagram that describes steps in a method that may be implemented by a client in accordance with one or more embodiments.

FIG. 3 is a flow diagram that describes steps in a method that may be implemented by a server in accordance with one or more embodiments.

FIG. 4 illustrates a user interface in accordance with one or more embodiments.

FIG. 5 is a block diagram of an example system in accordance with one or more embodiments.

### DETAILED DESCRIPTION

### Overview

Various embodiments enable device theme matching. In at least some embodiments, a request for resources from a client device can be configured to include data to identify a theme that is active for the client device and/or selected programs or interfaces of the device. The request for resources can be sent over a network to a web provider configured to make various resources (content and/or services) available over the network to clients. The web provider that receives the resource request can parse the request and process identifying data to ascertain a theme that is active for or associated with the client device. Based on the identifying data, the web provider can retrieve, generate, create, or otherwise obtain webpages that are configured to match or otherwise be consistent with the ascertained theme. The web provider can then communicate the configured webpages to the client device in response to the resource request.

In the discussion that follows, a section entitled “Operating Environment” describes but one environment in which various embodiments of device theme matching can be employed. Following this, a section entitled “Device Theme Matching Examples” describes example embodiments of device theme matching. Last, a section entitled “Example System” is provided and describes an example system that can be used to implement one or more embodiments.

Operating Environment

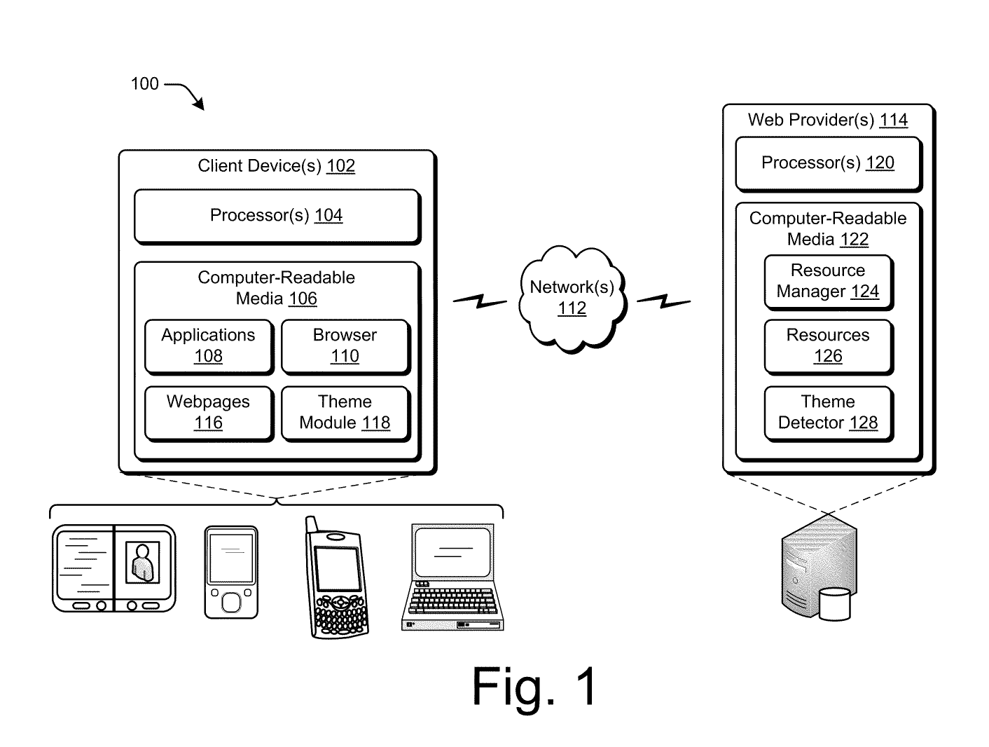

FIG. 1 illustrates an operating environment in accordance with one or more embodiments, generally at 100. Environment 100 includes a client device 102 having one or more processors 104, one or more computer-readable media 106 and one or more applications 108 that are stored on the computer-readable media and which are executable by the one or more processors 104. The client device 102 can be embodied as any suitable computing device such as, by way of example and not limitation, a portable computer, a handheld computer, a personal digital assistant (PDA), a mobile phone, a tablet, a desktop computer, and the like.

The computer-readable media 106 can include, by way of example and not limitation, all forms of volatile and non-volatile memory and/or storage media that are typically associated with a computing device. Such media can include ROM, RAM, flash memory, a hard disk, optical disks, removable storage media, and the like. The applications 108 can include any suitable type of application such as, by way of example and not limitation, an operating system, productivity applications, e-mail applications, instant messaging applications, games, and a variety of other applications.

Computer-readable media 106 is also depicted as storing a browser 110 that provides functionality available to a user of the client device 102 to navigate over a network 112, such as the Internet, to one or more web providers 114 from and to which communications and data can be received and sent. The web browser 110 can operate to obtain a variety of webpages 116 and other user interfaces through which the user may interact with resources that are available from the one or more web providers 114.

Further, the browser 110 can be configured to include or otherwise make use of a theme module 118 that operates as described above and below. The theme module 118 represents functionality operable by the client device 102 to implement aspects of device theme matching techniques described herein. For example, the theme module 118 can enable selection of various themes for a device and/or other device customizations. The theme module 118 can be implemented to enable user selections to selectively switch between multiple available themes. The theme module 118 can also configure resource requests with data that identifies a selected, a default, or an otherwise “active” theme for the device. In this manner, the theme module 118 enables web providers 114 that service resource requests to configure webpages and/or other resources to match or otherwise be consistent with the device theme.

An example web provider 114 is illustrated as having one or more processors 120, one or more computer-readable media 122, and a resource manager 124 that is stored on the computer-readable media 122 and which is executable by the one or more processors 120. Resource manager 124 represents functionality operable by the web provider 114 to manage various resources 126 that are stored on computer-readable media 122 and can be made available over the network 112. The resource manager 124 may manage access to the resources 126, performance of the resources 126, configuration of user interfaces, webpages, and/or data to provide the resources 126, and so on. For example, a client device 102 may form resource requests for communication to the web provider 114 to obtain corresponding resources 126. In response to receiving such requests, the web provider 114 can provide various resources 126 via webpages 116 and/or other user interfaces that are communicated over the network 112 for output by the one or more client devices 102.

Resources 126 can include any suitable combination of content and/or services typically made available over a network by one or more web providers. Content can include various combinations of text, video, ads, audio, multi-media streams, animations, images, webpages, web applications, device applications, content for display by a browser or other device application, and the like. Some examples of services include, but are not limited to, a search service, an email service to send and receive email, an instant messaging service to provide instant messages between clients, a theme service, and a social networking service to facilitate connections and interactions between groups of users who share common interests and activities.

The resource manager 124 can include or otherwise make use of a theme detector 128 that operates as described above and below. The theme detector 128 is depicted as being stored on the computer-readable media 122 and is executable by the one or more processors 120. The theme detector 128 represents functionality operable by the web provider 114 to implement aspects of device theme matching techniques described herein. For example, the theme detector 128 can operate to parse resource requests to detect data that identifies a theme selected for a corresponding client device 102. The theme detector 128 can also operate to cause a web provider 114 to respond to a resource request with webpages 116 and/or other resources that are configured to match or otherwise be consistent with a theme identified in the resource request. This can involve generating pages dynamically to match a theme, selecting pre-configured pages that match the theme from a suitable storage location, or otherwise obtaining matching pages for communication to the client device 102 over the network 112. Further discussion of device theme matching techniques that may be implemented by way of the theme module 118 and/or theme detector 128 can be found in relation to the following figures.

Having considered an example operating environment, consider now a discussion of example embodiments of device theme matching.

Device Theme Matching Examples

The following discussion describes device theme matching techniques that may be implemented utilizing the environment, systems, and/or devices described above and below. Aspects of each of the procedures below may be implemented in hardware, firmware, software, or a combination thereof. The procedures are shown as a set of blocks that specify operations performed by one or more devices and are not necessarily limited to the orders shown for performing the operations by the respective blocks. In portions of the following discussion, reference may be made to the example environment 100 of FIG. 1.

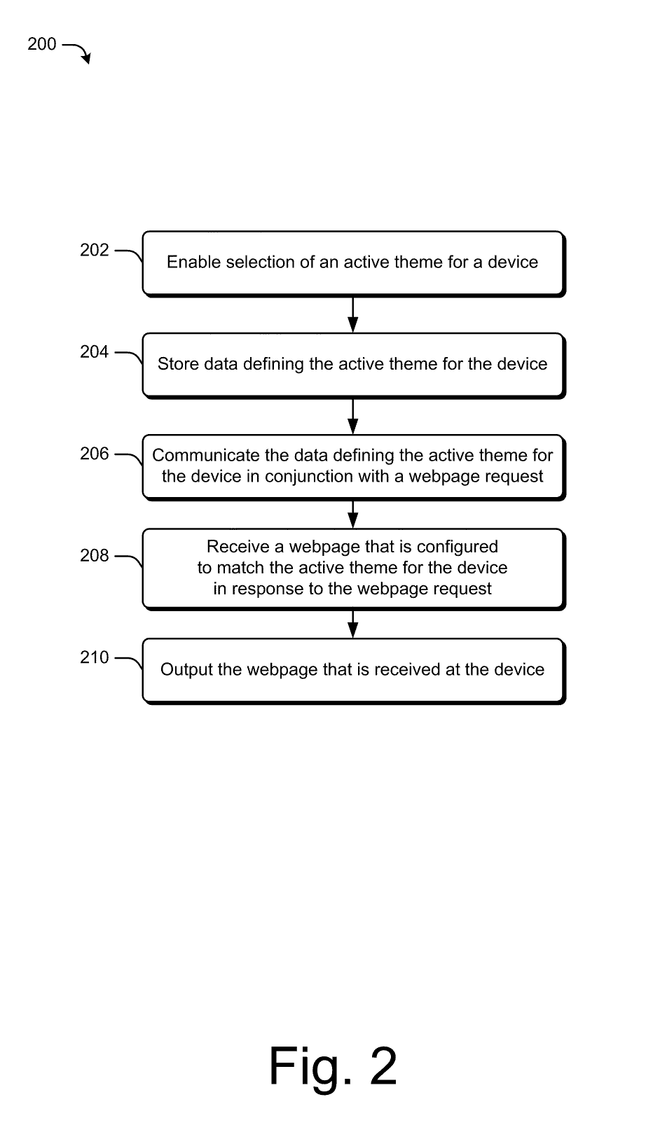

FIG. 2 is a flow diagram that describes an example procedure 200 in accordance with one or more embodiments. In at least some embodiments, the procedure 200 can be performed by a suitably configured computing device, such as a client device 102 of FIG. 1, or other computing device having a theme module 118.

Step 202 enables selection of an active theme for a device. For example, the theme module 118 of a client device 102 can operate to manage multiple user selectable themes. The theme module 118 can implement one or more pre-configured themes for the client device. The theme module can also enable a user to make selections to define a custom theme, navigate and download themes over the network 112, share themes between users and/or devices, install various themes, select an active theme, and so forth. Selection from among multiple themes for a device can be enabled in any suitable way. One way this can occur is through a theme settings user interface that can be exposed by the theme module. In addition or alternatively, theme management and selection can be enabled through device settings and/or a control panel interface of a client device 102 that is configured to manage a variety of different settings.

For example, the theme module 118 can operate to manage a list of available themes. A device can be pre-configured with any number of themes that have corresponding settings and identifying data that can be used to identify and reference the themes. A device can also include dynamically generated or user generated themes that are created using the device, downloaded from a theme service, or otherwise installed at the device. A list of available themes can be exposed via the theme settings interface, control panel interface, or other suitable interface of a device to enable selection of and/or switching between the themes. The theme module 118 can also be configured with functionality to enable a user to add or remove themes from the list. When a theme is selected, the theme can be applied to make the theme an “active” theme for the client device 102.

A theme for a device, as used herein, refers to a collection of settings that can be applied to change various user-perceptible aspects of the device. In other words, different themes can be applied to change “the look and feel” of user interfaces used by the device. In the context of device theme matching techniques described herein, this can include applying a theme to change “the look and feel” of web pages obtained from web providers to match the active theme of a device.

A theme can include at least various settings to control visual or other perceptible aspects of the user experience. The settings of a theme to control visual aspects can include color settings for text, lines, background, borders, and tables. A theme can also include a color scheme that can designate color choices for different user interface elements. In at least some embodiments, the color scheme can include one or more primary colors, one or more accent colors, one or more gradient colors, and one or more background colors. Colors of a theme can be associated with particular types of user interface elements to define color choices for the elements. When the theme is applied, elements can be colored to match corresponding color choices defined by the theme.

Settings of a theme to control visual aspects can also include graphic settings such as images and/or styles for the background, line weights, windows and borders, icons, element shadowing, opacity of elements, buttons and other controls, links, notifications and other pop-ups, and so forth. In addition, a theme can include text settings to enable selection of fonts, text size, text styles (normal, italics, bold, underline, numbered) and so forth. A theme can also include other settings that are related to behaviors of a user interface and/or elements of the user interface. By way of example and not limitation, a theme can include behavior settings to control transitions, touch input behaviors, control element behaviors, and auditory elements such as alert sounds, background music, ringtones, and so forth. Thus, a theme for a device can be configured to define a collection of settings to control visual aspects and/or behaviors of user interfaces for a device in accordance with the theme.

Step 204 stores data defining the active theme for the device. For instance, theme module 118 can store data describing a theme in response to selection of the theme by a user. The data defining the theme can be stored on computer-readable media 106 or other suitable storage of a client device 102. This causes the selected theme to become the “active” theme for the client device 102. The stored data can be configured as a theme name, a designated theme id, a mark-up language tag, a link, and/or any suitable data configured to identify the theme.

Step 206 communicates the data defining the active theme for the device in conjunction with a webpage request. For example, the theme module 118 can configure a request for a webpage or other resources sent by a client device 102 to a web provider 114 to include data that identifies an active theme of the client device 102. In particular, a theme name, a designated theme id, a mark-up language tag, a link, and/or any suitable data configured to identify the active theme can be passed with the webpage request in any suitable way using various techniques and communication protocols. For instance, theme identifying data can be passed by embedding the data in a page request or other suitable message that is communicated from the client device 102 to the web provider 114. The communication can be configured using any suitable techniques including, but not limited to, simple object access protocol (SOAP), hypertext transfer protocol (HTTP), and/or extensible markup language (XML), to name a few. In at least some examples, theme identifying data can be carried by way of one or more headers of a request or other message.

In one particular example, communication between a client device 102 and web provider 114 can occur according to a HTTP User-Agent (HTTP UA) model. In this example, the resource request can be configured to include one or more HTTP headers. An HTTP theme header can be defined and used to pass a theme identifier from a client device to the web provider. Further details regarding example HTTP UA techniques, theme headers, and other techniques suitable to communicate theme identifying data are described below.

Communication of data defining an active theme for a device in the manner just described enables the web provider 114 to discover the active theme and respond with requested webpages and/or other resources that are configured to match or otherwise be consistent with the active theme. In particular, step 208 receives a webpage that is configured to match the active theme for the device in response to the webpage request, and step 210 outputs the webpage that is received at the device. Outputting the webpage can include causing the webpage to be displayed on an associated client device. For instance, the browser 110, alone or with the aid of the theme module 118, can obtain and output a webpage 116 that is configured to match the active device theme. Accordingly, the webpages and/or other resources served by the web provider 114 are consistent with native user interfaces and applications of the client device 102, which can enhance the user experience.

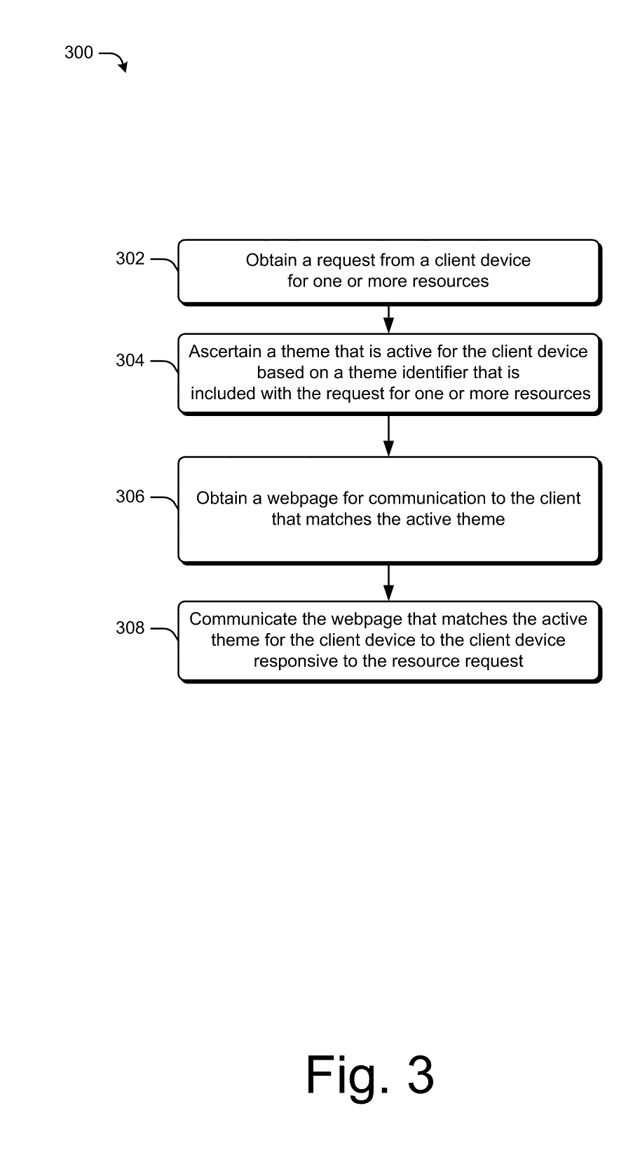

FIG. 3 is a flow diagram that describes another example procedure 300 in accordance with one or more embodiments. In at least some embodiments, the procedure 300 can be performed by a suitably configured computing device, such as a web provider 114 of FIG. 1, or other computing device having a theme detector 128.

Step 302 obtains a request from a client device for one or more resources. For instance, a resource manager 124 of a web provider 114 can be configured to receive and process resource requests from clients over a network 112. Various resources 126 can be served to the clients in response to the requests.

Step 304 ascertains a theme that is active for the client device based on a theme identifier that is included with the request for one or more resources. This step can be performed when a resource manager 124 processes a resource request from a client device 102. In particular, the resource manager 124 can include or otherwise make use of a theme detector 128 to parse the request and ascertain a theme associated with the request. Thus, the theme detector 128 provides functionality to detect theme identifying data that can be included in the resource request or other messages as discussed in relation to FIG. 2. The theme identifying data can include one or more of a theme name, a designated theme id, a mark-up language tag, a link, and/or any suitable data configured to identify the active theme. In at least some examples, the theme identifying data is encoded in a header portion of a suitable message. Additionally or alternatively, theme identifying data can be provided by way of a separate message, an attachment, a data field in the body of a message, or otherwise be passed in a communication from a client device 102. Any type of message, communication techniques, and/or communication protocols suitable to pass the theme identifying data from a client to a server can be employed. By way of example and not limitation, one or more embodiments can employ an HTTP UA model for at least some communications.

To facilitate understanding of the described techniques, consider now a discussion of some aspects of the HTTP UA model. In accordance with the HTTP UA model, a browser can identify itself via a User Agent (UA) String that can include or be sent along with a HTTP USER AGENT header as well as other headers. The UA string and/or various other headers can be sent for various HTTP methods. One format suitable for an identifying header is as follows:

Mozilla/4.0 (compatible; MSIE 6.0; Windows CE; IEMobile 6.12; <language-locale>; BrowserName.<deviceModel><version>)

There are three parameters in the example header format set forth above. A parameter <language-locale> specifies the locale-specific language in which the user is browsing. This enables web developers to return content in the appropriate language. A parameter <deviceModel> identifies the device form factor. Multiple form factors can exist for a device. Each can be associated with a different screen resolution and set of hardware capabilities. Accordingly, this parameter enables web developers to deliver content appropriate to the form factor. A parameter <version> specifies the version of the software running on the device.

As noted, the UA string can be sent along with various different HTTP headers. The headers can be used to define various characteristics of the data that is requested or the data that is provided using various HTTP methods. Some example headers include an operating system version header (HTTP_UA_OS), a color capability header (HTTP_UA_Color), a pixel resolution header (HTTP_UA_Pixels), and a processor type header (HTTP_UA_CPU), to name a few.

In accordance with device theme matching techniques described above and below, a theme header can be defined that is configured to pass theme identifying data. The theme header can be designated by a designator HTTP_UA_Theme or by another suitable header designator. The theme header can be sent along with the UA string and/or various other headers. The theme header can be configured to carry one or more parameters to at least identify a theme. The theme header can also be configured to carry one or more parameters to define device and/or UI settings selected for the theme to control the user experience.

Consider a particular example of a device that is pre-configured with a designated number of available themes. In other words, the device as manufactured and/or sold supports a set of themes that are pre-configured and/or pre-loaded by the manufacturer/seller. It should be noted that a device can be configured to support any number of pre-configured and custom themes, alone or in combination. Themes can also be updated and/or changed over time, such as being updated in conjunction with updates to the device code, updated via a theme service with which the device interacts, and so on. For the purpose of this example, though, assume there are just the four pre-configured themes. Accordingly, the device can be set to use and/or selectively switch between the four pre-configured themes.

The four pre-configured themes can each be associated with theme identifying data and various settings as discussed previously. Themes can be organized around a particular concept, such as a topic (politics, school, technology), group (band, social organization, church), color (green, blue, red), mood (warm, cold, wild, calm), activity (sports, sailing, golf), and so forth. To simplify development for web developers, the theme identifying data can be configured as a name associated with the particular concept of the theme.

Assume now that the four pre-configured themes are each organized around a particular color that is a dominant color associated with the particular theme. Correspondingly, the theme identifying data can be the name of the most dominant color associated with the theme. By way of example, the four pre-configured themes can be designated as “lime”, “blue”, “red”, and “pink” to match the dominant color. Other suitable theme designations can be made in a similar manner for different numbers and types of themes,

Accordingly, a theme header can be defined to distinguish between themes based on a name or other suitable identifying data associated with the theme. In the above example of four pre-configured themes organized around colors, the theme header can have the form HTTP_UA_Theme: <color(lime/blue/red/pink)>, where <color> is a parameter that can have values of lime, blue, red, or pink to identify a corresponding theme that is active for a device.

In the context of the HTTP UA model and theme header just described, the theme detector 128 can be configured to detect a theme header that is included in an HTTP UA request or other message. The theme detector 128 can further ascertain a corresponding theme as an active theme for the device based on the theme header. This can involve parsing or otherwise processing the message to obtain a theme name or other suitable theme identifying data.

Having ascertained an active theme corresponding to a device, step 306 obtains a webpage for communication to the client device. The webpage is configured to provide one or more resources and match the active theme for the client device. When a matching webpage has been obtained, step 308 communicates the webpage that matches the active theme for the client device to the client device responsive to the resource request.

Obtaining a webpage that matches the ascertained theme can occur in any suitable way. For example, a web provider 114 can maintain different pre-configured versions of a webpage that match different themes. The different versions can be stored on computer-readable media 122 or other suitable storage location accessible to the web provider. Thus, obtaining a matching webpage can involve obtaining a pre-configured webpage that matches an ascertained device theme from a suitable storage location.

Additionally or alternatively, a webpage or a portion thereof can be dynamically generated to match a detected theme responsive to a request for the page and/or identification of an active theme for a client device 102. In this example, obtaining a matching webpage can include applying one or more settings associated with the active theme “on the fly” to control the look and feel of a dynamically generated webpage.

The theme detector 128 can be programmed to support various themes. In particular, the theme detector 128 can be pre-configured with one or more themes and settings corresponding to the themes. Accordingly, when the theme detector 128 ascertains a theme from a request, the theme detector can look-up corresponding settings for the theme and apply the settings to serve webpages 116 and/or other resources 126 that match the theme.

Additionally or alternatively, the settings corresponding to a theme can be passed with the page request, such as being defined by parameters in one or more headers of the page request as described above and below. Accordingly, the theme detector 128 can be implemented to extract settings corresponding to a theme directly from a request and apply the settings to serve webpages 116 and/or other resources 126 that match the theme.

Further, in one or more embodiments, a theme service can be implemented to provide management of various themes. The theme service can be implemented by one or more servers of a web provider 114 and/or as a third party service. The management of themes provided by the theme service can include at least maintaining a plurality of pre-configured and/or custom themes, exposing theme related settings and data to client devices 102 and web providers 114 over the network 112, enabling users to register, distribute, and/or download themes, providing theme updates, and so forth.

The theme detector 128 can be configured to interact with the theme service to obtain a set of supported themes and/or settings for the themes. The theme detector 128 can download various theme related data for local storage and access to the data. The theme detector 128 can also keep theme related data current by registering to receive theme updates and/or by periodically checking for new themes and/or data from the theme service. Theme detector 128 can further operate to obtain theme settings for a particular theme or other data from the theme service on demand, such as in response to detecting a previously unknown theme in a request from a device. It is noted that a theme module 118 of a client device 102 can also be configured to interact with the theme service, such as by exposing a theme settings interface to enable user selections to download and install a set of supported themes and/or settings for the themes. The theme module 118 can further operate to enable user selections to register a custom theme with the theme service and thereby make the theme available to other devices and/or users. Thus, a theme service can be implemented to manage supported themes and/or settings for the themes and to provide techniques for devices, users, and providers to obtain current theme information, add new themes, create and/or share custom themes, and so forth.

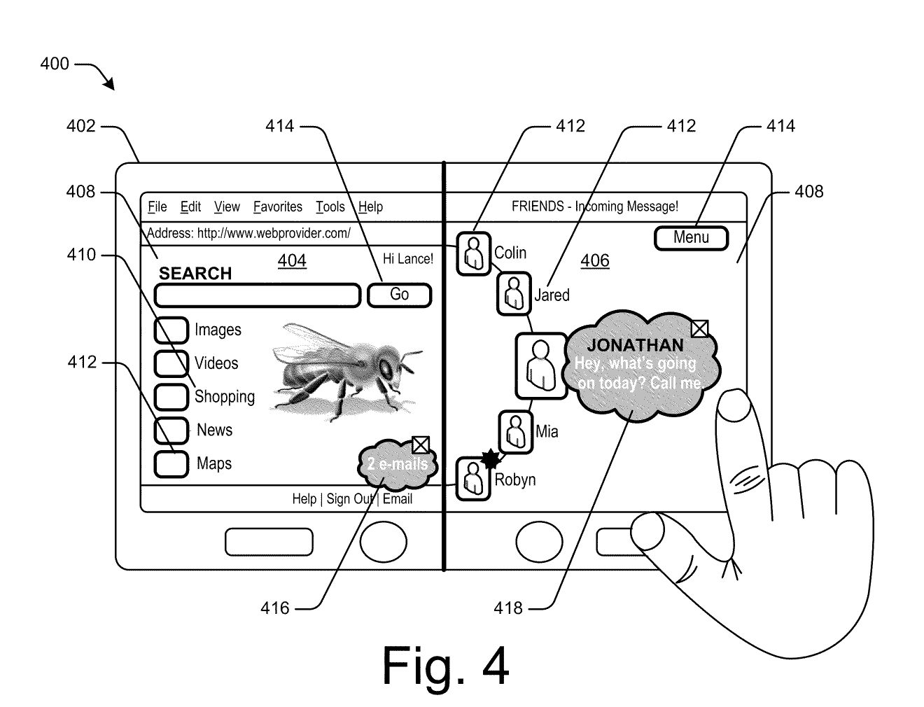

FIG. 4 illustrates, generally at 400, an example client device 402 configured to implement device theme matching techniques. The example client device 402 is depicted as a mobile device that has two display screens or windows. The example client device 402 having two display screens or windows is provided in order to simultaneously show aspects of multiple user interfaces. Naturally, other devices can make use of theme matching techniques in conjunction with user interfaces that are rendered successively using a single screen or window.

On the left-hand display a webpage 404 is depicted as being rendered and on the right-hand display a device user interface 406 for a social networking application is depicted as being rendered. The device user interface 406 is representative of one or more native user interfaces and/or applications of the example client device 402 that can be configured to appear in accordance with an active theme for the device. The active theme can include settings for various visual aspects and/or behaviors to control the look and feel of the device user interface 406 in the manner described herein. Further, the device 402 can be configured to include theme identifying data in web page requests to enable web providers 114 to match the active device theme.

Thus, in accordance with device theme matching techniques described above and below, various aspects and elements appear in the webpage 404 of FIG. 4 that are configured to match the device theme that is active for the example client device 402. This can be observed by a comparison of the webpage 404 to the device user interface 406. By way of example, characteristics of the illustrated webpage 404 and device user interface 406 that match include colors selections 408, font sizes and styles 410, icons, lines, and borders 412, and control button styles 414. Further, the style, color, fonts, and other characteristics of an email alert 416 of the webpage 404 matches a message alert 418 of the device user interface 406. These matching characteristics can be driven by theme identifying data that is included in a web page request in accordance with device theme matching techniques described herein. In this manner, a consistent user experience that has a common look and feel can be provided for various different interactions of a user with the client device 402.

Having described various embodiments in which techniques for device theme matching can be employed, consider now a discussion of an example system that can be utilized to implement the embodiments described above.

Example System

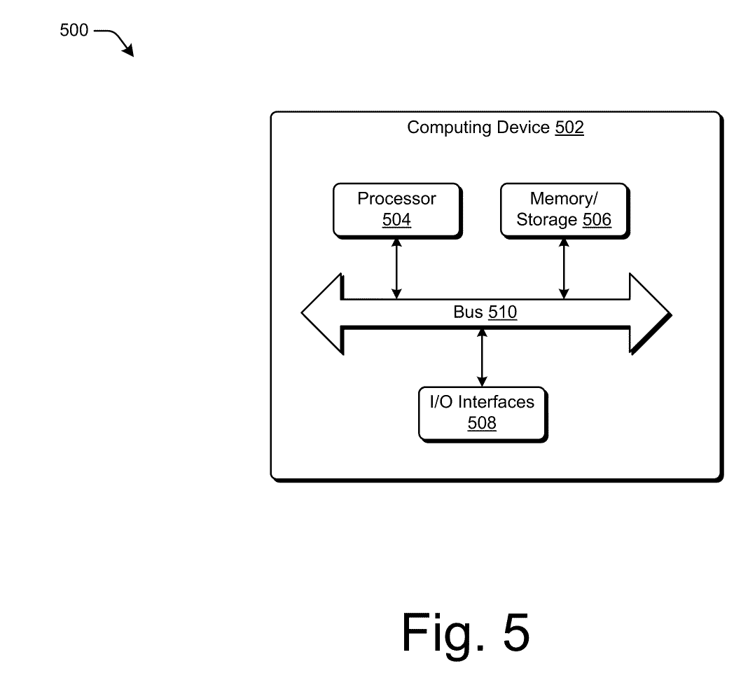

FIG. 5 illustrates generally at 500 an example computing device 502 that may implement the various embodiments described above. The computing device 502 may be, for example, a client device 102 of FIG. 1, a server of a web provider 114, or any other suitable computing device.

The computing device 502 includes one or more processors 504 or processing units, one or more memory and/or storage components 506, one or more input/output (I/O) interfaces 508 for input/output (I/O) devices, and a bus 510 that allows the various components and devices to communicate one to another. The bus 510 represents one or more of several types of bus structures, including a memory bus or memory controller, a peripheral bus, an accelerated graphics port, and a processor or local bus using any of a variety of bus architectures. The bus 510 can include wired and/or wireless buses.

The memory/storage component 506 represents one or more computer storage media. The memory/storage component 506 may include volatile media (such as random access memory (RAM)) and/or nonvolatile media (such as read only memory (ROM), Flash memory, optical disks, magnetic disks, and so forth). The memory/storage component 506 may include fixed media (e.g., RAM, ROM, a fixed hard drive, etc.) as well as removable media (e.g., a Flash memory drive, a removable hard drive, an optical disk, and so forth).

The one or more input/output interfaces 508 allow a user to enter commands and information to computing device 500, and also allow information to be presented to the user and/or other components or devices using various input/output devices. Examples of input devices include a keyboard, a cursor control device (e.g., a mouse), a microphone, a scanner, and so forth. Examples of output devices include a display device (e.g., a monitor or projector), speakers, a printer, a network card, and so forth.

Various techniques may be described herein in the general context of software or program modules. Generally, software includes routines, programs, objects, components, data structures, and so forth that perform particular tasks or implement particular abstract data types. An implementation of these modules and techniques may be stored on or transmitted across some form of computer-readable media. The computer-readable media may include a variety of available medium or media that may be accessed by a computing device. By way of example, and not limitation, computer-readable media may comprise “computer-readable storage media.”

Software or program modules, including the theme module 118, applications 108, resource manager 124, theme detector 128, and other program modules, may be embodied as one or more instructions stored on computer-readable storage media. The computing device 502 may be configured to implement particular functions corresponding to the software or program modules stored on computer-readable storage media. Such instructions may be executable by one or more articles of manufacture (for example, one or more computing devices 502, and/or processors 504) to implement techniques for device theme matching, as well as other techniques. Such techniques include, but are not limited to, the example procedures described herein. Thus, computer-readable storage media may be configured to store instructions that, when executed by one or more devices described herein, cause various techniques for inventory management.

The computer-readable storage media includes volatile and non-volatile, removable and non-removable media implemented in a method or technology suitable for storage of information such as computer readable instructions, data structures, program modules, or other data. The computer-readable storage media can include, but is not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or another tangible media or article of manufacture suitable to store the desired information and which may be accessed by a computer.

### CONCLUSION

Although the techniques for device theme matching have been described in language specific to structural features and/or methodological steps, it is to be understood that the techniques defined in the appended claims are not necessarily limited to the specific features or steps described. Rather, the specific features and steps are disclosed as example forms of implementing the claimed techniques.

What is claimed is:

1. A computer-implemented method comprising:
communicating data defining an active theme for a device in conjunction with a webpage request; and
receiving, in response to the webpage request, a webpage that is configured to match the active theme for the device based on the data defining the active theme.

2. The computer-implemented method of claim 1, further comprising outputting, at the device, the received webpage that matches the active theme for the device.

3. The computer-implemented method of claim 1, further comprising storing the data defining the active theme for the device responsive to selection of the active theme.

4. The computer-implemented method of claim 1, wherein the webpage is configured to enable interaction with one or more resources available from a web provider.

5. The computer-implemented method of claim 1, wherein communicating the data defining the active theme for the device comprises communicating the data to a web provider to enable the web provider to configure the web page to match the active theme for the device.

6. The computer-implemented method of claim 1, wherein the webpage request comprises a hypertext transfer protocol (HTTP) request and the data defining the active theme for the device is encoded in a HTTP header of the HTTP request.

7. The computer-implemented method of claim 1, wherein the active theme is configured to define one or more visual aspects of elements of a user interface.

8. The computer-implemented method of claim 7, wherein the active theme is further configured to define one or more behaviors of elements of the user interface.

9. The computer-implemented method of claim 1, wherein the data defining the active theme comprises a designated theme name associated with the active theme.

10. The computer-implemented method of claim 9, wherein the data defining the active theme further comprises a plurality of settings associated with the active theme to define visual aspects and behaviors of elements of user interfaces of the device to control a look and feel of the user interfaces including controlling the look and feel for webpages output by the device.

11. A computer-implemented method comprising:
obtaining a request from a client device for one or more resources;
ascertaining a theme that is active for the client device based upon a theme identifier that is included with the request;
obtaining a webpage for communication to the client device, the webpage configured to provide the one or more resources and match the active theme for the client device; and
communicating that webpage that matches the active theme for the client device to the client device responsive to the resource request.

12. The computer-implemented method of claim 11, wherein the resource request comprises a hypertext transfer protocol (HTTP) request and the theme identifier is encoded in a HTTP header of the HTTP request.

13. The computer-implemented method of claim 12, wherein the hypertext transfer protocol (HTTP) request further comprises one or more headers configured to include settings associated with the theme to define visual aspects and behaviors to control a look and feel for user interfaces output by the client device.

14. The computer-implemented method of claim 11, wherein obtaining the webpage comprises:
using the theme identifier to look-up one or more settings associated with the active theme; and
dynamically generating the webpage to match the active theme in accordance with the one or more settings associated with the active theme.

15. The computer-implemented method of claim 11, wherein obtaining the webpage comprises using the theme identifier to select a webpage that is preconfigured to match the active theme.

16. A client device comprising:
one or more computer readable storage media;
computer readable instructions embodied on the one or more computer readable storage media which, when executed by the client device, implement a theme module configured to:
enable selection of an active theme for the client device from among a plurality of available themes for the client device;
communicate a hypertext transfer protocol (HTTP) theme header configured to include data describing the active theme for the client device in conjunction with a HTTP request for one or more resources from a web provider;
receive a webpage from the web provider that is configured to match the active theme for the client device and provide the one or more resources in response to the HTTP request; and
output the received webpage that matches the active theme for the client device at the client device.

17. The client device of claim 16, wherein the plurality of available themes includes one or more preconfigured themes and one or more user customized themes.

18. The client device of claim 16, wherein each of the plurality of available themes is configured to define one or more visual aspects of elements for user interfaces of the device to control a look and feel of the user interfaces.

19. The client device of claim 16, wherein the HTTP request further comprises one or more headers configured to pass settings associated with the active theme to the web provider to enable the web provider to configure the webpage to match the active theme for the client device.

20. The client device of claim 16, wherein the theme module is further configured to expose a theme settings interface that enables user selections to at least:
selectively switch between the plurality of available themes;
define settings to create a custom theme; and
interact with a theme service over a network to register and download themes.
